(19) United States
(12) Patent Application Publication
(10) Pub. No.: US 2013/0227543 A1
(43) Pub. Date: Aug. 29, 2013

(54) SERVER DEPLOYMENT SYSTEM AND METHOD FOR UPDATING DATA

(71) Applicant: Chih-Ming Chen, New Taipei City (TW)

(72) Inventor: Chih-Ming Chen, New Taipei City (TW)

(73) Assignee: WISTRON CORPORATION, New Taipei City (TW)

(21) Appl. No.: 13/477,066

(22) Filed: May 22, 2012

(30) Foreign Application Priority Data
Feb. 24, 2012 (TW) 101106329

(51) Int. Cl. G06F 9/44

(52) U.S. Cl. 717/173; 717/172

(57) ABSTRACT

A server deployment system and a method for updating data are provided. A system management server is added to the server deployment system for providing an update data. In a server system, a main server receives the update data from the system management server. The update data includes a controller firmware and a main server software. A firmware updating instruction is transmitted to a device controller to allow the device controller to update its original firmware into the controller firmware. If the controller firmware is successfully updated, the main server updates its original software into the main server software. If the main server software is not successfully updated, a firmware rollback instruction is transmitted to the device controller to allow the device controller to rollback to its original firmware. If the main server software is successfully updated, the system management server is notified.

### CROSS-REFERENCE TO RELATED APPLICATION

This application claims the priority benefit of Taiwan application serial no. 101106329, filed on Feb. 24, 2012. The entirety of the above-mentioned patent application is hereby incorporated by reference herein and made a part of this specification.

### BACKGROUND OF THE INVENTION

1. Field of the Invention

The invention generally relates to a server system management mechanism, and more particularly, to a server deployment system that can update firmware and software at the same time and a method for updating data.

2. Description of Related Art

Nowadays, server systems are broadly deployed in different enterprises. Besides being applied to the Internet and telecommunication industry, server systems are also applied to different aspects in our daily life, such as finance, business, online banking, and online credit card. All these applications rely on the powerful operation ability of servers.

A server system includes various embedded chips, such as fan control boards (FCBs), power control units, and baseboard management controllers (BMC) of servers, and all these embedded chips require firmware to operate. However, it is difficult to ensure the synchronism between server software and aforementioned firmware. Namely, it is difficult to maintain the compatibility between software and firmware.

### SUMMARY OF THE INVENTION

Accordingly, the invention is directed to a server deployment system and a method for updating data, in which server software and controller firmware are updated at the same time.

The invention provides a server deployment system including a system management server and a server system. The server system is coupled to the system management server. The server system includes a plurality of internal devices and a main server. The system management server provides an update data. The update data includes a controller firmware and a main server software. Each of the internal devices is coupled to a device controller. The main server is coupled to each of the device controllers and communicates with the system management server via a network. The main server receives the update data from the system management server and transmits a firmware updating instruction to each of the device controllers to allow each of the device controllers to update their firmware to the corresponding controller firmware. If the controller firmware is successfully updated, a software of the main server is updated to the main server software. If the main server software is not successfully updated, a firmware rollback instruction is transmitted to each of the device controllers to allow the original firmware of the device controllers to be rollbacked. If the main server software is successfully updated, the system management server is notified.

According to an embodiment of the invention, the server system includes at least a first chassis, a second chassis, and a third chassis. The first chassis is coupled to a fan controller. The fan controller manages the fan speed of the first chassis. The first chassis includes at least one sled, at least one host is installed on the sled, and the sled is coupled to a sled controller. The second chassis includes a power control unit and a power controller. The power control unit is coupled to the power controller. The third chassis includes a main server, a backup server, and a position controller. The main server is coupled to the fan controller, the sled controller, and the power controller. The backup server is coupled to the main server. The backup server inquires the main server at fixed intervals and replaces the main server when no response is received from the main server within a predetermined time range. The position controller is coupled to the sled controller and configured to assign a network address to the sled controller. The fan controller, the sled controller, the power controller, and the position controller are respectively a kind of device controller.

The invention also provides a data updating method adapted to a main server. The main server is in a server system and coupled to device controllers of a plurality of internal devices of the server system. In the data updating method, an update data is received from a system management server, wherein the update data includes a controller firmware and a main server software, and the system management server communicates with the main server via a network. A firmware updating instruction is transmitted to the device controllers to allow the device controllers to update their original firmware to the controller firmware. If the controller firmware is successfully updated, a software of the main server is updated to the main server software. If the main server software is not successfully updated, a firmware rollback instruction is transmitted to the device controllers to allow the original firmware of the device controllers to be rollbacked. If the main server software is successfully updated, the system management server is notified.

According to an embodiment of the invention, the server system further includes a backup server, and the update data further includes a backup server software. If the controller firmware is successfully updated, a software updating instruction is transmitted to the backup server to update a software of the backup server to the backup server software. If the backup server software is not successfully updated, a firmware rollback instruction is transmitted to the device controller to allow the original firmware of the device controllers to be rollbacked. If the backup server software is successfully updated, the software of the main server is updated to the main server software.

According to an embodiment of the invention, if the main server software is not successfully updated after the step of updating the software of the main server to the main server software, a software rollback instruction is transmitted to the backup server to allow the original software of the backup server to be rollbacked, and a firmware rollback instruction is transmitted to the device controllers to allow the original firmware of the device controllers to be rollbacked.

According to an embodiment of the invention, before the step of transmitting the firmware updating instruction to the device controllers, a digital signature of the controller firmware is further verified. If the digital signature of the controller firmware passes the verification, the firmware updating instruction is transmitted to the device controllers. If the digital signature of the controller firmware does not pass the verification, subsequent updating procedure is terminated.

According to an embodiment of the invention, if the controller firmware of the device controllers is successfully updated, a digital signature of the backup server software is further verified. If the digital signature of the backup server software passes the verification, a software updating instruction is transmitted to the backup server. If the digital signature of the backup server software does not pass the verification, a firmware rollback instruction is transmitted to the device controllers.

According to an embodiment of the invention, if the backup server software of the backup server is successfully updated, a digital signature of the main server software is further verified. If the digital signature of the main server software passes the verification, the software of the main server is updated to the main server software. If the digital signature of the main server software does not pass the verification, a software rollback instruction is transmitted to the backup server, and a firmware rollback instruction is transmitted to the device controllers.

According to an embodiment of the invention, after the step of receiving the update data from the system management server, the update data is stored into a database. A hardware configuration of the internal devices coupled to the device controllers is checked, so as to select a controller firmware compatible to the hardware configuration from the database. A fan speed table compatible to the hardware configuration is also selected from the database, so as to allow the device controllers to download controller firmware and fan speed tables compatible to the hardware configuration when the firmware updating instruction is transmitted to the device controllers.

According to an embodiment of the invention, before the step of receiving the update data from the system management server, an update downloading instruction is transmitted to the system management server, or an update request instruction is received from the system management server.

As described above, in the invention, an atomic operation is executed to update server software and controller firmware at the same time. Namely, either both the firmware of a device controller and the software of a main server are successfully updated or none of the two is successfully updated. Thereby, the synchronism between firmware and software is ensured.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a server deployment system according to a first embodiment of the invention.

FIG. 2 is a block diagram of a server system according to the first embodiment of the invention.

FIG. 3 is a flowchart of a data updating method according to the first embodiment of the invention.

FIG. 4 is a block diagram of a server deployment system according to a second embodiment of the invention.

FIG. 5 is a flowchart of a data updating method according to the second embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

FIG. 1 is a block diagram of a server deployment system according to the first embodiment of the invention. Referring to FIG. 1, the server deployment system 100 includes a system management server 110 and at least one server system (in the present embodiment, two server systems 120 and 130 are illustrated as examples). The system management server 110 manages the server systems 120 and 130 through a network 140. Below, components of the server system 120 will be described in detail with reference to another embodiment. Components of the server system 130 are the same as or similar to those of the server system 120 therefore will not be described herein.

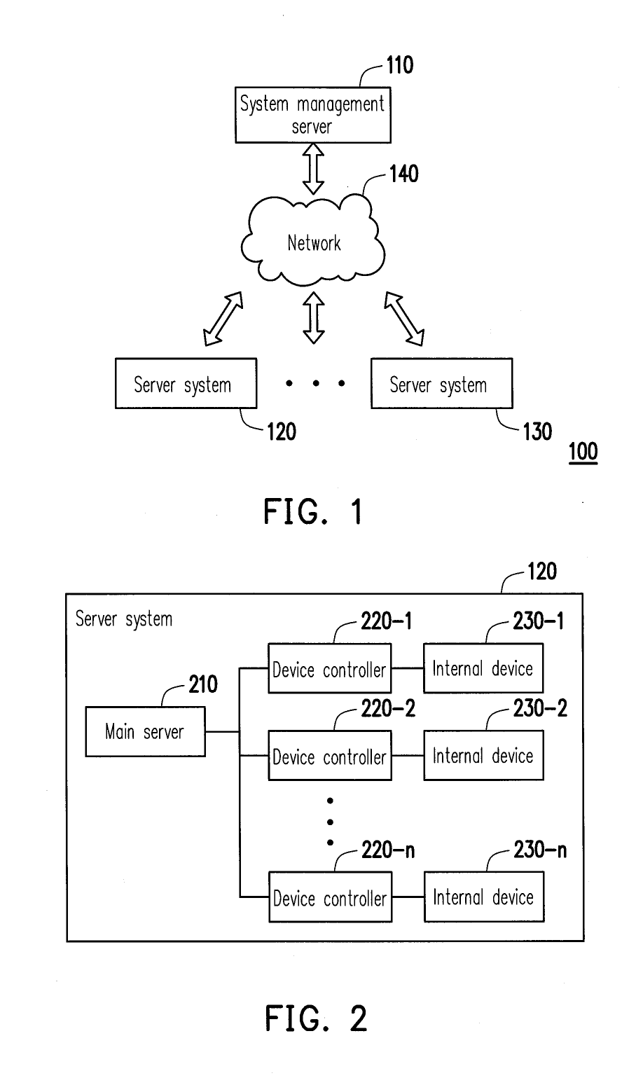

FIG. 2 is a block diagram of a server system according to the first embodiment of the invention. Referring to FIG. 1 and FIG. 2, the server system 120 includes a main server 210, internal devices 230-1-230-n, and device controllers 220-1-220-n. The internal devices 230-1-230-n are respectively coupled to the device controllers 220-1-220-n, and the device controllers 220-1-220-n are coupled to the main server 210. Herein the device controllers 220-1-220-n may be fan controllers, power controllers, sled controllers, and position controllers.

Taking a rack server system as an example, the rack server system includes at least one rack, each rack includes at least one chassis, each chassis includes at least one sled, and one or more hosts are disposed on each sled. In the rack server system, each chassis is coupled to a fan controller, each sled is coupled to a sled controller, and a power controller is coupled to a power supply. Besides, each rack has a position controller.

The main server 210 communicates with the system management server 110 through the network 140. The system management server 110 provides an update data. The update data includes controller firmware for updating the device controllers 220-1-220-n and main server software for updating the main server 210.

When the main server 210 receives the update data from the system management server 110, it executes an atomic operation to update firmware of the device controllers 220-1-220-n and software of the main server 210. For example, the main server 210 first updates the firmware of each of the device controllers 220-1-220-n and then the software of the main server 210. If the firmware of one of the device controllers 220-1-220-n is not successfully updated, the original firmware of each of the device controllers 220-1-220-n is rollbacked and the software of the main server 210 is not updated. After the firmware of each of the device controllers 220-1-220-n is successfully updated, the software of the main server 210 is updated into the main server software. If the software of the main server 210 is not successfully updated, the original firmware of each of the device controllers 220-1-220-n is rollbacked. Besides, the original software of the main server 210 may be further rollbacked.

In short, either both the firmware of each of the device controllers 220-1-220-n and the software of the main server 210 are successfully updated or none of the firmware of each of the device controllers 220-1-220-n and the software of the main server 210 is updated.

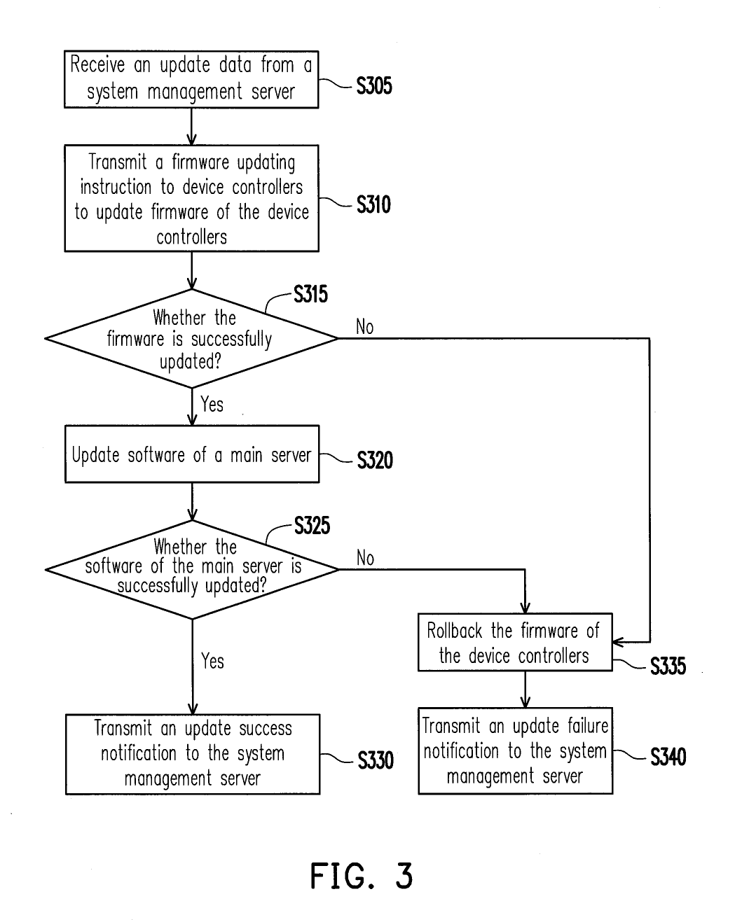

Below, the procedure for updating data in a server system will be explained with reference to the server deployment system 100 described above. FIG. 3 is a flowchart of a data updating method according to the first embodiment of the invention. The communication between the system management server 110 and the server system 120 will be taken as an example in the present embodiment, and the communication between the server system 130 and the system management server 110 is the same as or similar to that described in the present embodiment therefore will not be described herein.

Referring to FIGS. 1-3, in step S305, the main server 210 receives an update data from the system management server 110. The main server 210 may transmit an update downloading instruction to the system management server 110 to request the system management server 110 to transmit the update data. Or, the system management server 110 may also automatically detect whether the server system 120 wants to perform any update. For example, when the system management server 110 detects that the version of the firmware and software of the server system 120 does not match that of the update data, the system management server 110 automatically transmits an update request instruction and the update data to the main server 210.

After receiving the update data, the main server 210 stores the update data into a database thereof Besides, the main server 210 checks the hardware configuration of the internal devices 203-1-203-n coupled to the device controllers 220-1-220-n. After that, the main server 210 selects a controller firmware compatible to the hardware configuration from the database. In addition, the main server 210 also selects a fan speed table compatible to the hardware configuration from the database, so as to allow each of the device controllers 220-1-220-n to download the controller firmware and the fan speed table compatible to the hardware configuration when the firmware updating instruction is transmitted to each of the device controllers 220-1-220-n.

Next, in step S310, the main server 210 transmits a firmware updating instruction to the device controllers 220-1-220-n to update firmware of the device controllers 220-1-220-n. When the device controllers 220-1-220-n receive the firmware updating instruction, they respectively download corresponding controller firmware from the main server 210 and update their firmware to the downloaded controller firmware.

After that, in step S315, the main server 210 determines whether the firmware is successfully updated. For example, the main server 210 can determine whether the firmware is successfully updated according to whether responses are received from the device controllers 220-1-220-n. Besides, the main server 210 may also determine that the firmware is not successfully updated if no response is received within a predetermined time range.

If the controller firmware is not successfully updated, step S335 is executed to rollback the firmware of the device controllers 220-1-220-n. For example, the main server 210 transmits a firmware rollback instruction to the device controllers 220-1-220-n to allow the original firmware of the device controllers 220-1-220-n to be rollbacked. The device controllers 220-1-220-n first back up their original firmware when they receive the firmware updating instruction, so that the original firmware can be rollbacked if the subsequent updating operation fails. In step S340, the main server 210 transmits an update failure notification to the system management server 110.

On the other hand, if the controller firmware is successfully updated, step S320 is executed, in which the main server 210 updates its software into the main server software. Besides, in step S325, whether the software of the main server 210 is successfully updated is determined. If the software of the main server 210 is successfully updated, step S330 is executed, in which the main server 210 transmits an update success notification to the system management server 110.

If the main server software is not successfully updated, step S335 is executed, in which the main server 210 transmits a firmware rollback instruction to the device controllers 220-1-220-n to allow the original firmware of the device controllers 220-1-220-n to be rollbacked. Thereafter, in step S340, the main server 210 transmits an update failure notification to the system management server 110.

Thereby, a user can manage server systems easily through a system management server and can successfully update both or none of software and firmware, so as to ensure the synchronism between the software and the firmware, through the method described above. In other words, such situation that only the firmware or only the software is successfully updated (and accordingly the corresponding device controller cannot operate) can be avoided.

### Second Embodiment

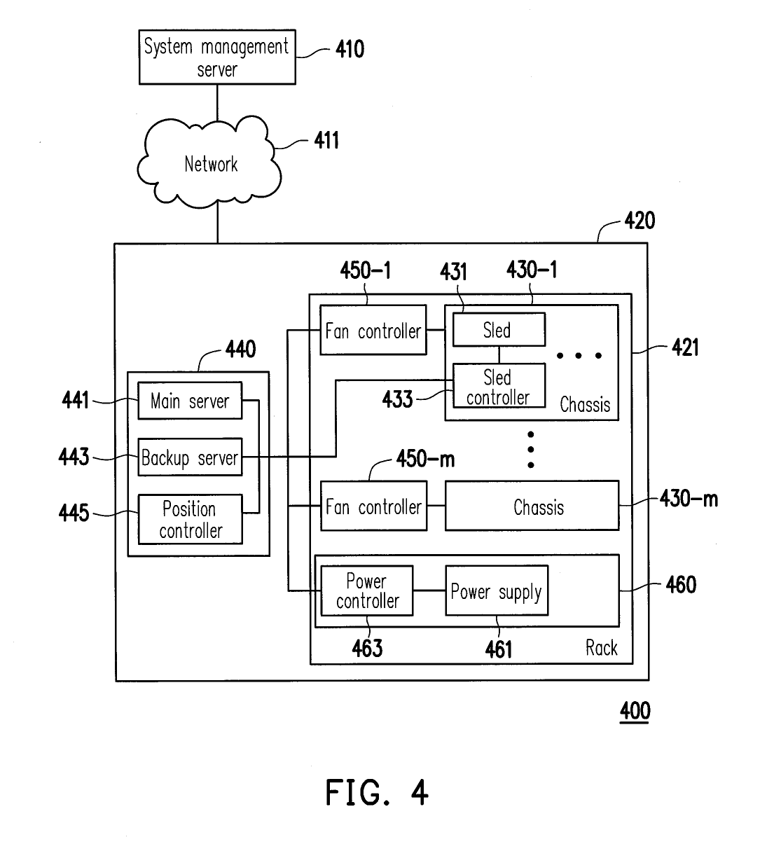

FIG. 4 is a block diagram of a server deployment system according to the second embodiment of the invention. For the convenience of description, only one server system is taken as an example in the present embodiment. However, the invention is not limited thereto, and in other embodiments, the server deployment system 400 may also include two or more server systems.

Referring to FIG. 4, the server deployment system 400 includes a system management server 410 and a server system 420, and the system management server 410 communicates with the server system 420 through a network 411.

The server system 420 may be a rack server system, and which includes at least one rack 421. Herein a single rack 421 will be taken as an example, while in other embodiments, the server system 420 may include two or more racks.

The rack 421 includes chassis 430-1˜430-m. The chassis 430-1˜430-m are respectively coupled to fan controllers 450-1˜450-m. The fan controllers 450-1˜450-m are respectively configured to manage the fan speeds of the chassis 430-1˜430-m.

Herein the chassis 430-1 will be taken as an example, and the other chassis can be understood by referring to related descriptions of the chassis 430-1. The chassis 430-1 includes at least one sled 431. One or more hosts can be installed on the sled 431, and the sled 431 is coupled to a sled controller 433. For example, the sled controller 433 communicates with the console of firmware (for example, the basic input output system (BIOS)) of each host installed on the sled 431. Each host executes a single operating system (OS), such as the Windows OS or the Linux OS.

The server system 420 further includes a chassis 440 for deploying a main server 441, a backup server 443, and a position controller 445. The main server 441 is a primary domain server (PDS) coupled to the fan controllers 450-1-450-m, the sled controller 433, and a power controller 463. The main server 441 controls the communication between racks.

The backup server 443 is a secondary domain server (SDS) coupled to the main server 441. The backup server 443 inquires the main server 441 at fixed intervals and replaces the main server 441 when no response is received from the main server 441 within a predetermined time range. For example, when the main server 441 stops working, the backup server 443 enables its network functions and uses the same Internet protocol (IP) address and media access control (MAC) address as the main server 441, so that the backup server 443 can replace the main server 441.

The position controller 445 is coupled to the sled controller 433 and configured to assign a network address to the sled controller 433. Besides, the network address of the sled controller 433 can be determined by both the position controller 445 and the sled controller 433. Moreover, the chassis 440 may also be coupled to a fan controller (not shown).

The chassis 440 may also be placed in the rack 421. Namely, each rack 421 comes with one main server 441. However, the invention is not limited thereto, and in other embodiments, a main server 441 may also be shared by multiple racks.

The rack 421 further includes a chassis 460 for deploying a power supply 461 and the power controller 463. The power controller 463 manages the power supply 461.

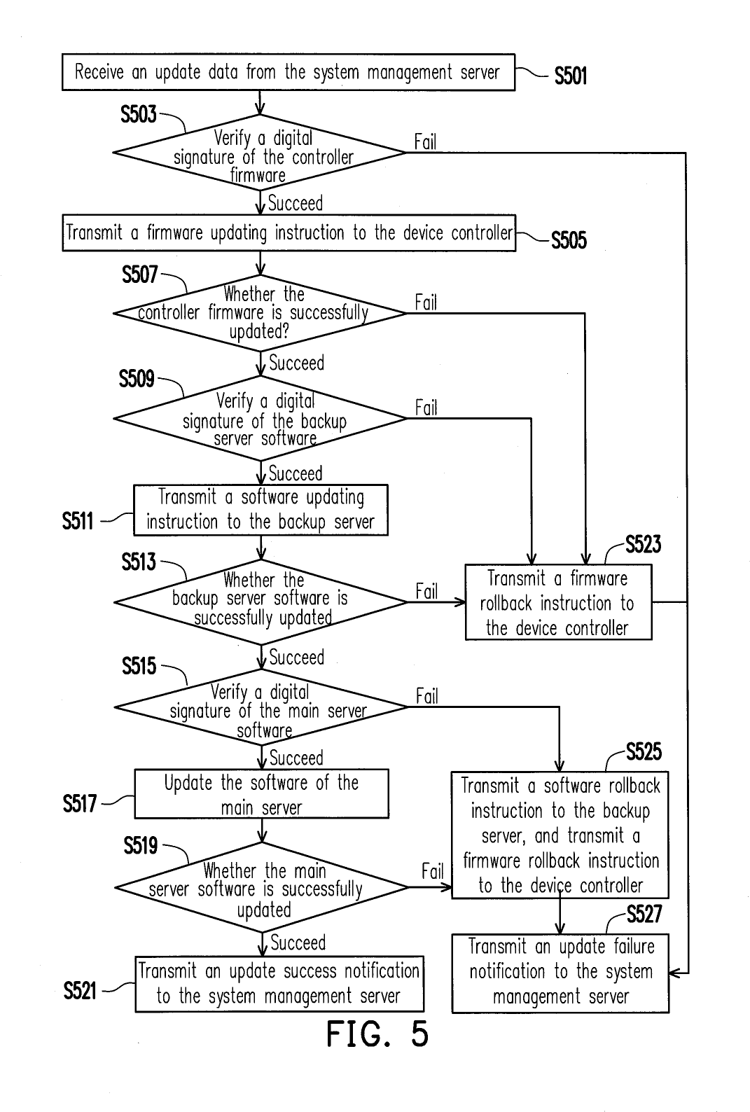

Below, a data updating procedure will be described in detail with reference to the server deployment system 400 described above. FIG. 5 is a flowchart of a data updating method according to the second embodiment of the invention. In following description, the term “device controller” is used for referring to at least one or a random combination of the fan controllers 450-1-450-m, the sled controller 433, the power controller 463, and the position controller 445.

Referring to both FIG. 4 and FIG. 5, in step 5501, the main server 441 receives an update data from the system management server 410. The update data includes a controller firmware, a main server software, and a backup server software. The main server 441 can take the initiative to request the update data from the system management server 410, or the system management server 410 can compulsively request the main server 441 to update.

Once the update data is received, the main server 441 stores the update data into a database thereof. The database may be a yellow dog updater modified (YUM) repository. The main server 441 checks the hardware configuration of the sled controller 433 through proactive query, so as to find a compatible controller firmware in the YUM repository. Besides, the main server 441 searches for a compatible fan speed table in the YUM repository to be used along with the controller firmware. If no compatible fan speed table is found, a predetermined fan speed table is used. In addition, if no compatible controller firmware is found, an update downloading instruction is transmitted to the system management server 410 to download a compatible controller firmware.

Because each sled may be provided by different manufacturer, the hardware configuration of each sled controller 433 needs to be detected in advance to ensure the compatibility between the controller firmware and the fan speed table provided to the sled controller 433. For example, if the sled controller 433 is provided by a manufacturer A, a controller firmware and a fan speed table complying with specifications established by manufacturer A are searched for in the YUM repository.

Next, in step S503, the main server 441 verifies a digital signature of the controller firmware. By verifying the digital signature, the identify of the supplier can be determined so that it is ensured that the controller firmware comes from a safe source. For example, a key pair (i.e., the public key and private key theory) is adopted, anyone who transmits information can use the private key to encrypt the information, and when the digital signature is verified, the information is decrypted by using the public key. However, the invention is not limited to the example described herein.

If the digital signature of the controller firmware does not pass the verification, subsequent updating procedure is stopped and step S527 is executed, in which the main server 441 transmits an update failure notification to the system management server 410 to terminate the entire updating procedure.

If the digital signature of the controller firmware passes the verification, step S505 is executed, in which a firmware updating instruction is transmitted to the device controller. After the device controller receives the firmware updating instruction, it downloads the corresponding controller firmware from the database of the main server 441 and upgrades (or downgrades) its firmware to the controller firmware downloaded from the database.

Assuming that the device controllers to be updated include the fan controllers 450-1˜450-m, the sled controller 433, the power controller 463, and the position controller 445, after the main server 441 verifies the controller firmware corresponding to each of these device controllers, it respectively issues a firmware updating instruction to the fan controllers 450-1˜450-m, the sled controller 433, the power controller 463, and the position controller 445 to allow these device controllers to respectively download the corresponding controller firmware from the main server 441.

After that, in step S507, whether the controller firmware is successfully updated is determined. The main server 441 may determine whether the controller firmware is successfully updated according to whether a response is received from each device controller. The main server 441 may also determine that the controller firmware is not successfully updated if no response is received within a predetermined time range.

If the controller firmware is not successfully updated, step S523 is executed, in which a firmware rollback instruction is transmitted to the device controller. In step S527, an update failure notification is transmitted to the system management server 410 and subsequent updating procedure is ended. It should be noted that if more than one device controller is to be updated and one of them is not successfully updated, step S523 is executed, in which a firmware rollback instruction is respectively transmitted to these device controllers to allow the original firmware of these device controllers to be rollbacked. Thereafter, step S527 is executed to end the updating procedure.

On the other hand, if the controller firmware is successfully updated (i.e., all the controller firmware is successfully updated), in step S509, a digital signature of the backup server software is verified. If the digital signature of the backup server software passes the verification, in step S511, the main server 441 transmits a software updating instruction to the backup server 443. Contrarily, if the digital signature of the backup server software does not pass the verification, step S523 is executed to rollback to the original firmware of the device controller. Next, step S527 is executed, in which an update failure notification is transmitted to the system management server 410, and subsequent updating procedure is ended.

Back to step S511, after the software updating instruction is transmitted to the backup server 443, the backup server 443 downloads the corresponding backup server software from the main server 441 and updates its software to the downloaded backup server software. Next, in step S513, whether the backup server software is successfully updated is determined.

If the backup server software is not successfully updated, step S523 and step S527 are executed. If the backup server software is successfully updated, step S515 is executed to verify a digital signature of the main server software. If the digital signature of the main server software passes the verification, step S517 is executed, in which the main server 441 updates its own software to the main server software. If the digital signature of the main server software does not pass the verification, step S525 and step S527 are executed.

In step S525, the main server 441 transmits a software rollback instruction to the backup server 443 and transmits a firmware rollback instruction to the device controller to rollback to the original software of the backup server 443 and rollback to the original firmware of the device controller.

After step S517, step S519 is executed to determine whether the main server software is successfully updated. If the main server software is successfully updated, step S521 is executed. If the main server software is not successfully updated, step S525 and step S527 are executed. In step S521, the main server 441 transmits an update success notification to the system management server 410 to notify the system management server 410 that all updates are done.

It should be noted that before updating their software and firmware, the main server 441, the backup server 443, and the device controller first back up their original software and original firmware, so that the original software and the original firmware can be rollbacked if subsequent updating operation or verification fails.

As described above, in an embodiment of the invention, a main server executes an atomic operation to update server software and controller firmware at the same time. Namely, either both the firmware of a device controller and the software of a main server are successfully updated or none of the two is successfully updated. In addition, before updating the firmware of the device controller, the main server first verifies the compatibility between the controller firmware and the device controller. Thereby, the synchronism and compatibility between firmware and software are ensured

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A data updating method, adapted to a main server, wherein the main server is in a server system and coupled to a device controller of each of a plurality of internal devices of the server system, the data updating method comprising:
receiving an update data from a system management server, wherein the update data comprises a controller firmware and a main server software, and the system management server communicates with the main server via a network;
transmitting a firmware updating instruction to the device controller to allow the device controller to update original firmware of the device controller into the controller firmware;
when the controller firmware is successfully updated, updating a software of the main server into the main server software;
when the main server software is not successfully updated, transmitting a firmware rollback instruction to the device controller to allow the device controller to rollback to the original firmware; and
when the main server software is successfully updated, notifying the system management server.

2. The data updating method according to claim 1, wherein the server system further comprises a backup server, the update data further comprises a backup server software, and when the controller firmware is successfully updated, the data updating method further comprises:
transmitting a software updating instruction to the backup server to allow the backup server to update an original software of the backup server into the backup server software;
when the backup server software is not successfully updated, transmitting the firmware rollback instruction to the device controller to allow the device controller to rollback to the original firmware; and
when the backup server software is successfully updated, updating the software of the main server into the main server software.

3. The data updating method according to claim 2, wherein after the step of updating the software of the main server into the main server software, the data updating method further comprises:
when the main server software is not successfully updated, transmitting a software rollback instruction to the backup server to allow the backup server to rollback to the original software of the backup server, and transmitting the firmware rollback instruction to the device controller to allow the device controller to rollback to the original firmware.

4. The data updating method according to claim 3, wherein before the step of transmitting the firmware updating instruction to the device controller, the data updating method further comprises:
verifying a digital signature of the controller firmware;
when the digital signature of the controller firmware passes the verification, transmitting the firmware updating instruction to the device controller; and
when the digital signature of the controller firmware does not pass the verification, terminating subsequent updating procedure.

5. The data updating method according to claim 4, wherein when the controller firmware is successfully updated, the data updating method further comprises:
verifying a digital signature of the backup server software;
when the digital signature of the backup server software passes the verification, transmitting the software updating instruction to the backup server; and
when the digital signature of the backup server software does not pass the verification, transmitting the firmware rollback instruction to the device controller.

6. The data updating method according to claim 5, wherein when the backup server software is successfully updated, the data updating method further comprises:
verifying a digital signature of the main server software;
when the digital signature of the main server software passes the verification, updating the software of the main server into the main server software; and
when the digital signature of the main server software does not pass the verification, transmitting the software rollback instruction to the backup server, and transmitting the firmware rollback instruction to the device controller.

7. The data updating method according to claim 1, wherein after the step of receiving the update data from the system management server, the data updating method further comprises:
storing the update data into a database;
checking a hardware configuration of an internal device coupled to the device controller;
selecting the controller firmware compatible to the hardware configuration from the database; and
selecting a fan speed table compatible to the hardware configuration from the database to allow the device controller to download the controller firmware and the fan speed table compatible to the hardware configuration when the firmware updating instruction is transmitted to the device controller.

8. The data updating method according to claim 1, wherein before the step of receiving the update data from the system management server, the data updating method further comprises:
transmitting an update downloading instruction to the system management server.

9. The data updating method according to claim 1, wherein before the step of receiving the update data from the system management server, the data updating method further comprises:
receiving an update request instruction from the system management server.

10. A server deployment system, comprising:
a system management server, providing an update data, wherein the update data comprises a controller firmware and a main server software; and
a server system, coupled to the system management server, wherein the server system comprises:
a plurality of internal devices, wherein each of the internal devices is coupled to a device controller; and
a main server, coupled to the device controller, and communicating with the system management server via a network, wherein the main server receives the update data from the system management server and transmits a firmware updating instruction to the device controller to allow the device controller to update an original firmware of the device controller into the controller firmware, wherein when the controller firmware is successfully updated, a software of the main server is updated into the main server software, when the main server software is not successfully updated, a firmware rollback instruction is transmitted to the device controller to allow the device controller to rollback to the original firmware, and when the main server software is successfully updated, the system management server is notified.

11. The server deployment system according to claim 10, wherein the server system further comprises a backup server, and the update data further comprises a server software;
wherein when the controller firmware is successfully updated, the main server transmits a software updating instruction to the backup server to allow the backup server to update an original software of the backup server into the backup server software, when the backup server software is not successfully updated, the main server transmits the firmware rollback instruction to the device controller to allow the device controller to rollback to the original firmware, when the backup server software is successfully updated, the main server updates the software of the main server into the main server software, and when the main server software is not successfully updated, the main server transmits a software rollback instruction to the backup server to allow the backup server to rollback to the original software of the backup server, and the main server transmits the firmware rollback instruction to the device controller to allow the device controller to rollback to the original firmware.

12. The server deployment system according to claim 11, wherein before the main server transmits the firmware updating instruction to the device controller, the main server verifies a digital signature of the controller firmware, wherein when the digital signature of the controller firmware passes the verification, the main server transmits the firmware updating instruction to the device controller, and when the digital signature of the controller firmware does not pass the verification, the main server terminates subsequent updating procedure.

13. The server deployment system according to claim 12, wherein when the controller firmware is successfully updated, the main server verifies a digital signature of the backup server software, wherein when the digital signature of the backup server software passes the verification, the main server transmits the software updating instruction to the backup server, and when the digital signature of the backup server software does not pass the verification, the main server transmits the firmware rollback instruction to the device controller.

14. The server deployment system according to claim 13, wherein when the backup server software is successfully updated, the main server verifies a digital signature of the main server software, wherein when the digital signature of the main server software passes the verification, the main server updates the software of the main server into the main server software, and when the digital signature of the main server software does not pass the verification, the main server transmits the software rollback instruction to the backup server and transmits the firmware rollback instruction to the device controller.

15. The server deployment system according to claim 11, wherein the server system comprises:
at least one first chassis, coupled to a fan controller, wherein the fan controller manages a fan speed of the first chassis, the first chassis comprising:
at least one sled, wherein at least one host is installed on the sled, and the sled is coupled to a sled controller;
a second chassis, comprising:
a power control unit, coupled to a power controller; and
a third chassis, comprising:
the main server, coupled to the fan controller, the sled controller, and the power controller;
the backup server, coupled to the main server, wherein the backup server inquires the main server at fixed intervals and replaces the main server when no response is received from the main server within a predetermined time range; and
a position controller, coupled to the sled controller, and configured to assign a network address to the sled controller;
wherein the fan controller, the sled controller, the power controller, and the position controller are respectively the device controller.

16. The server deployment system according to claim 10, wherein the main server further comprises a database, and the update data is stored into the database.

17. The server deployment system according to claim 16, wherein the main server checks a hardware configuration of an internal device coupled to the device controller and selects the controller firmware and a fan speed table compatible to the hardware configuration from the database, so as to allow the device controller to download the controller firmware and the fan speed table compatible to the hardware configuration when the firmware updating instruction is transmitted to the device controller.

18. The server deployment system according to claim 10, wherein the main server transmits an update downloading instruction to the system management server to allow the system management server to transmit the update data.

19. The server deployment system according to claim 10, wherein the system management server automatically transmits an update request instruction to the main server to allow the main server to execute updating operations.
